(19) United States
(12) Patent Application Publication
(10) Pub. No.: US 2023/0260053 A1
(43) Pub. Date: Aug. 17, 2023

(54) METHOD AND SYSTEM FOR PROVIDING GEOSPATIAL INFORMATION

(71) Applicant: JPMorgan Chase Bank, N.A., New York, NY (US)

(72) Inventors: Matthew LANSDELL, Worthington, OH (US); Jonathan BOCANEGRA, Delaware, OH (US); Robert RAPPA, Berkeley Heights, NJ (US)

(73) Assignee: JPMorgan Chase Bank, N.A., New York, NY (US)

(21) Appl. No.: 18/108,308

(22) Filed: Feb. 10, 2023

Related U.S. Application Data
(60) Provisional application No. 63/268,027, filed on Feb. 15, 2022.

(51) Int. Cl. G06Q 40/12; G06F 16/909; G06F 16/906

(52) U.S. Cl. CPC G06Q 40/12; G06F 16/909; G06F 16/906

(57) ABSTRACT

A method for providing geospatial information for clustered merchants based on proximate transactional data is disclosed. The method includes retrieving, via an application programming interface, transaction data for a geographical location that corresponds to the clustered merchants based on a predetermined parameter; identifying, from the transaction data, the proximate transactional data that correspond to the clustered merchants; linking transactions in the proximate transactional data to each of the clustered merchants; computing a weighted score for each of the transactions based on a characteristic; calculating a transaction centroid for each of the clustered merchants by using the corresponding weighted score and a result of the linking; and determining the geospatial information for each of the clustered merchants based on a distance to the corresponding transaction centroid.

### CROSS-REFERENCE TO RELATED APPLICATIONS

This application claims the benefit of U.S. Provisional Patent Application Ser. No. 63/268,027, filed Feb. 15, 2022, which is hereby incorporated by reference in its entirety.

### BACKGROUND

### 1. Field of the Disclosure

This technology generally relates to methods and systems for geospatial information, and more particularly to methods and systems for providing geospatial information for clustered merchants based on proximate transactional data to facilitate enrichment of transaction records.

### 2. Background Information

Many business entities provide transactional insight by utilizing large quantities of transactional data. Often, the transactional insight enables clients such as, for example, merchants to granularly analyze transactional trends. Historically, implementations of conventional transaction systems have resulted in varying degrees of success with respect to providing geospatial information about individual transactions.

One drawback of using the conventional transaction systems is that in many instances, the conventional transaction systems only provide limited pieces of location information such as, for example, a zip code in transaction data. As a result, for clustered merchants with multiple locations in the same zip code, data for a particular transaction may be very difficult to attribute to a particular shop when several of the same shops are in one single zip code. Additionally, without accurate attribution of transactions for the particular shop, the transaction data may not be enriched to provide geospatial information such as, for example, a store address.

Therefore, there is a need to provide geospatial information for clustered merchants based on proximate transactional data of customer purchases at other merchants to facilitate enrichment of transaction records.

### SUMMARY

The present disclosure, through one or more of its various aspects, embodiments, and/or specific features or sub-components, provides, inter alia, various systems, servers, devices, methods, media, programs, and platforms for providing geospatial information for clustered merchants based on proximate transactional data to facilitate enrichment of transaction records.

According to an aspect of the present disclosure, a method for providing geospatial information for at least one clustered merchant based on proximate transactional data is disclosed. The method is implemented by at least one processor. The method may include retrieving, via an application programming interface, transaction data for a geographical location that corresponds to the at least one clustered merchant based on a predetermined parameter; identifying, from the transaction data, the proximate transactional data that corresponds to the at least one clustered merchant; linking at least one transaction in the proximate transactional data to each of the at least one clustered merchant; computing a weighted score for each of the at least one transaction based on at least one characteristic; calculating a transaction centroid for each of the at least one clustered merchant by using the corresponding weighted score and a result of the linking; and determining the geospatial information for each of the at least one clustered merchant based on a distance to the corresponding transaction centroid.

In accordance with an exemplary embodiment, the predetermined parameter may include a zip code parameter, the zip code parameter may include a radial distance from the at least one clustered merchant that is automatically adjusted based on a location density of the at least one clustered merchant.

In accordance with an exemplary embodiment, the proximate transactional data may include customer transaction data that is within a proximity of the at least one clustered merchant, the customer transaction data may include the at least one transaction that is made at another merchant by a customer of the at least one clustered merchant.

In accordance with an exemplary embodiment, the at least one characteristic may include at least one from among a time characteristic and an exponential decay characteristic, the time characteristic may include a time difference between a first transaction at the at least one clustered merchant and a second transaction at another merchant.

In accordance with an exemplary embodiment, the method may further include computing at least one uncertainty metric for the geospatial information that corresponds to each of the at least one clustered merchant, the at least one uncertainty metric may correspond to a relative uncertainty value of the determined geospatial information; generating at least one graphical element, the at least one graphical element may include information that relates to the at least one clustered merchant, the corresponding geospatial information, and the corresponding at least one uncertainty metric; and displaying, via a graphical user interface, the at least one graphical element.

In accordance with an exemplary embodiment, the geospatial information is determined by using at least one model, the at least one model may include at least one from among a machine learning model, a statistical model, a mathematical model, a process model, and a data model.

In accordance with an exemplary embodiment, the method may further include receiving, via a graphical user interface, at least one data enrichment request, the at least one data enrichment request may relate to instruction to append a set of the transaction data with corresponding contextual information; and enriching the set of the transaction data with the corresponding geospatial information, wherein the geospatial information may be associated with the corresponding at least one clustered merchant in the set of the transaction data.

In accordance with an exemplary embodiment, the geospatial information may relate to location specific information that corresponds to each of the at least one clustered merchant, the location specific information may include at least one from among a street address, a latitude, and a longitude of the at least one clustered merchant.

In accordance with an exemplary embodiment, the transaction centroid may correspond to a geometric center of the proximate transactional data for each of the at least one clustered merchant, the geometric center may represent an arithmetic mean position between each of a plurality of transaction points in the proximate transactional data.

According to an aspect of the present disclosure, a computing device configured to implement an execution of a method for providing geospatial information for at least one clustered merchant based on proximate transactional data is disclosed. The computing device including a processor; a memory; and a communication interface coupled to each of the processor and the memory, wherein the processor may be configured to retrieve, via an application programming interface, transaction data for a geographical location that corresponds to the at least one clustered merchant based on a predetermined parameter; identify, from the transaction data, the proximate transactional data that correspond to the at least one clustered merchant; link at least one transaction in the proximate transactional data to each of the at least one clustered merchant; compute a weighted score for each of the at least one transaction based on at least one characteristic; calculate a transaction centroid for each of the at least one clustered merchant by using the corresponding weighted score and a result of the linking; and determine the geospatial information for each of the at least one clustered merchant based on a distance to the corresponding transaction centroid.

In accordance with an exemplary embodiment, the predetermined parameter may include a zip code parameter, the zip code parameter may include a radial distance from the at least one clustered merchant that is automatically adjusted based on a location density of the at least one clustered merchant.

In accordance with an exemplary embodiment, the proximate transactional data may include customer transaction data that is within a proximity of the at least one clustered merchant, the customer transaction data may include the at least one transaction that is made at another merchant by a customer of the at least one clustered merchant.

In accordance with an exemplary embodiment, the at least one characteristic may include at least one from among a time characteristic and an exponential decay characteristic, the time characteristic may include a time difference between a first transaction at the at least one clustered merchant and a second transaction at another merchant.

In accordance with an exemplary embodiment, the processor may be further configured to compute at least one uncertainty metric for the geospatial information that corresponds to each of the at least one clustered merchant, the at least one uncertainty metric may correspond to a relative uncertainty value of the determined geospatial information; generate at least one graphical element, the at least one graphical element may include information that relates to the at least one clustered merchant, the corresponding geospatial information, and the corresponding at least one uncertainty metric; and display, via a graphical user interface, the at least one graphical element.

In accordance with an exemplary embodiment, the processor may be further configured to determine the geospatial information by using at least one model, the at least one model may include at least one from among a machine learning model, a statistical model, a mathematical model, a process model, and a data model.

In accordance with an exemplary embodiment, the processor may be further configured to receive, via a graphical user interface, at least one data enrichment request, the at least one data enrichment request may relate to instruction to append a set of the transaction data with corresponding contextual information; and enrich the set of the transaction data with the corresponding geospatial information, wherein the geospatial information may be associated with the corresponding at least one clustered merchant in the set of the transaction data.

In accordance with an exemplary embodiment, the geospatial information may relate to location specific information that corresponds to each of the at least one clustered merchant, the location specific information may include at least one from among a street address, a latitude, and a longitude of the at least one clustered merchant.

In accordance with an exemplary embodiment, the transaction centroid may correspond to a geometric center of the proximate transactional data for each of the at least one clustered merchant, the geometric center may represent an arithmetic mean position between each of a plurality of transaction points in the proximate transactional data.

According to an aspect of the present disclosure, a non-transitory computer readable storage medium storing instructions for providing geospatial information for at least one clustered merchant based on proximate transactional data is disclosed. The storage medium including executable code which, when executed by a processor, may cause the processor to retrieve, via an application programming interface, transaction data for a geographical location that corresponds to the at least one clustered merchant based on a predetermined parameter; identify, from the transaction data, the proximate transactional data that correspond to the at least one clustered merchant; link at least one transaction in the proximate transactional data to each of the at least one clustered merchant; compute a weighted score for each of the at least one transaction based on at least one characteristic; calculate a transaction centroid for each of the at least one clustered merchant by using the corresponding weighted score and a result of the linking; and determine the geospatial information for each of the at least one clustered merchant based on a distance to the corresponding transaction centroid.

In accordance with an exemplary embodiment, the predetermined parameter may include a zip code parameter, the zip code parameter may include a radial distance from the at least one clustered merchant that is automatically adjusted based on a location density of the at least one clustered merchant.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing geospatial information for clustered merchants based on proximate transactional data to facilitate enrichment of transaction records.

FIG. 4 is a flowchart of an exemplary process for implementing a method for providing geospatial information for clustered merchants based on proximate transactional data to facilitate enrichment of transaction records.

FIG. 5 is a weighted score and transaction centroid screen shot that illustrates a graphical user interface that is usable for implementing a method for providing geospatial information for clustered merchants based on proximate transactional data to facilitate enrichment of transaction records, according to an exemplary embodiment.

FIG. 6 is a geospatial information screen shot that illustrates a graphical user interface that is usable for implementing a method for providing geospatial information for clustered merchants based on proximate transactional data to facilitate enrichment of transaction records, according to an exemplary embodiment.

FIG. 7 is a screen shot of a data enrichment table that illustrates a graphical user interface that is usable for implementing a method for providing geospatial information for clustered merchants based on proximate transactional data to facilitate enrichment of transaction records, according to an exemplary embodiment.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

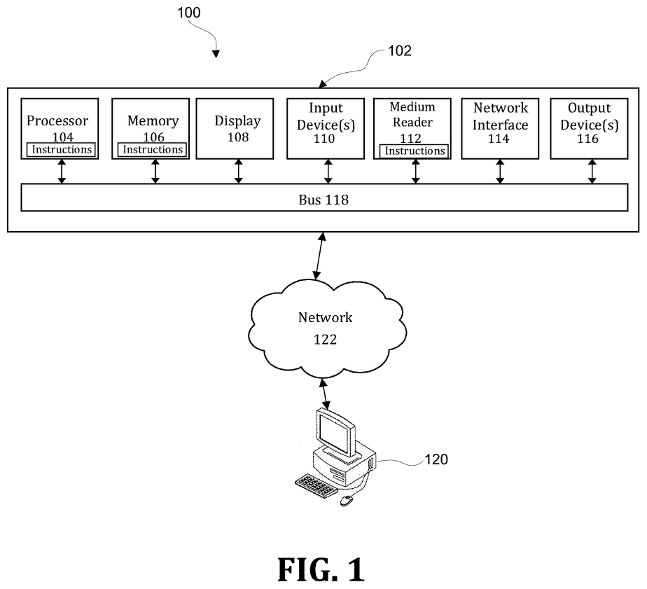

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are known to persons of ordinary skill in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing geospatial information for clustered merchants based on proximate transactional data to facilitate enrichment of transaction records.

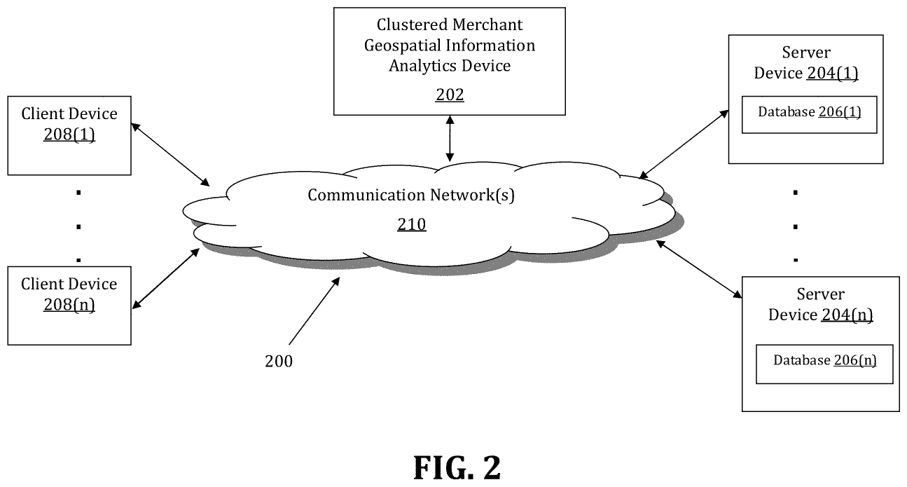

Referring to FIG. 2, a schematic of an exemplary network environment 200 for implementing a method for providing geospatial information for clustered merchants based on proximate transactional data to facilitate enrichment of transaction records is illustrated. In an exemplary embodiment, the method is executable on any networked computer platform, such as, for example, a personal computer (PC).

The method for providing geospatial information for clustered merchants based on proximate transactional data to facilitate enrichment of transaction records may be implemented by a Clustered Merchant Geospatial Information Analytics (CMGIA) device 202. The CMGIA device 202 may be the same or similar to the computer system 102 as described with respect to FIG. 1. The CMGIA device 202 may store one or more applications that can include executable instructions that, when executed by the CMGIA device 202, cause the CMGIA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CMGIA device 202 itself, may be located in virtual server(s) running in a cloud-based computing environment rather than being tied to one or more specific physical network computing devices. Also, the application(s) may be running in one or more virtual machines (VMs) executing on the CMGIA device 202. Additionally, in one or more embodiments of this technology, virtual machine(s) running on the CMGIA device 202 may be managed or supervised by a hypervisor.

In the network environment 200 of FIG. 2, the CMGIA device 202 is coupled to a plurality of server devices 204(1)-204(n) that hosts a plurality of databases 206(1)-206(n), and also to a plurality of client devices 208(1)-208(n) via communication network(s) 210. A communication interface of the CMGIA device 202, such as the network interface 114 of the computer system 102 of FIG. 1, operatively couples and communicates between the CMGIA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CMGIA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CMGIA devices that efficiently implement a method for providing geospatial information for clustered merchants based on proximate transactional data to facilitate enrichment of transaction records.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CMGIA device 202 may be a standalone device or integrated with one or more other devices or apparatuses, such as one or more of the server devices 204(1)-204(n), for example. In one particular example, the CMGIA device 202 may include or be hosted by one of the server devices 204(1)-204(n), and other arrangements are also possible. Moreover, one or more of the devices of the CMGIA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CMGIA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to transaction data, parameter information, characteristic information, proximate transactional data, clustered merchants, weighted scores, transaction centroids, and geospatial information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CMGIA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CMGIA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CMGIA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CMGIA device 202, the server devices 204(1)-204(n), or the client devices 208(1)-208(n), for example, may be configured to operate as virtual instances on the same physical machine. In other words, one or more of the CMGIA device 202, the server devices 204(1)-204(n), or the client devices 208(1)-208(n) may operate on the same physical device rather than as separate devices communicating through communication network(s) 210. Additionally, there may be more or fewer CMGIA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

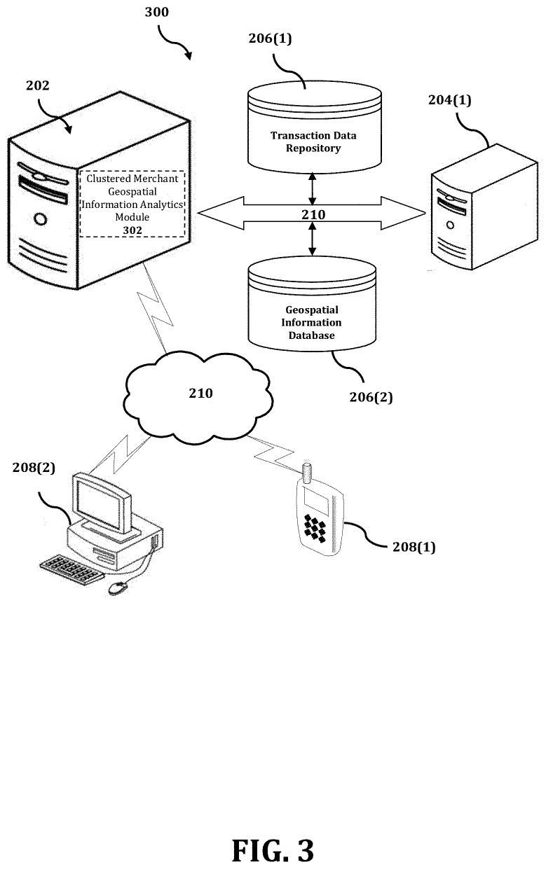

The CMGIA device 202 is described and shown in FIG. 3 as including a clustered merchant geospatial information analytics module 302, although it may include other rules, policies, modules, databases, or applications, for example. As will be described below, the clustered merchant geospatial information analytics module 302 is configured to implement a method for providing geospatial information for clustered merchants based on proximate transactional data to facilitate enrichment of transaction records.

An exemplary process 300 for implementing a mechanism for providing geospatial information for clustered merchants based on proximate transactional data to facilitate enrichment of transaction records by utilizing the network environment of FIG. 2 is shown as being executed in FIG. 3. Specifically, a first client device 208(1) and a second client device 208(2) are illustrated as being in communication with CMGIA device 202. In this regard, the first client device 208(1) and the second client device 208(2) may be “clients” of the CMGIA device 202 and are described herein as such. Nevertheless, it is to be known and understood that the first client device 208(1) and/or the second client device 208(2) need not necessarily be “clients” of the CMGIA device 202, or any entity described in association therewith herein. Any additional or alternative relationship may exist between either or both of the first client device 208(1) and the second client device 208(2) and the CMGIA device 202, or no relationship may exist.

Further, CMGIA device 202 is illustrated as being able to access a transaction data repository 206(1) and a geospatial information database 206(2). The clustered merchant geospatial information analytics module 302 may be configured to access these databases for implementing a method for providing geospatial information for clustered merchants based on proximate transactional data to facilitate enrichment of transaction records.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CMGIA device 202 via broadband or cellular communication. Of course, these embodiments are merely exemplary and are not limiting or exhaustive.

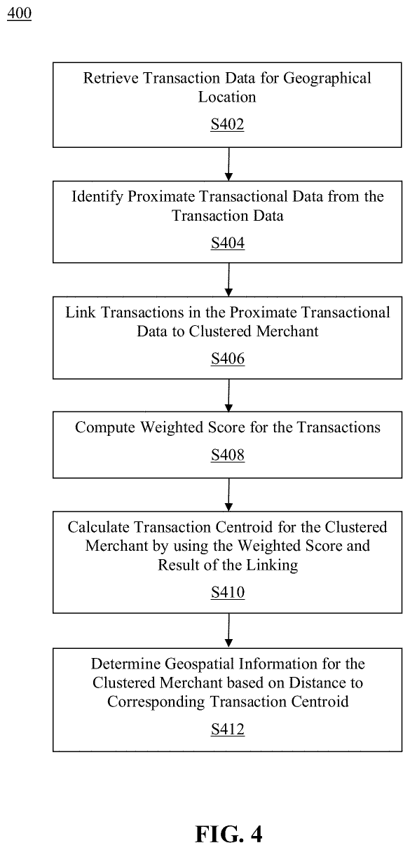

Upon being started, the clustered merchant geospatial information analytics module 302 executes a process for providing geospatial information for clustered merchants based on proximate transactional data to facilitate enrichment of transaction records. An exemplary process for providing geospatial information for clustered merchants based on proximate transactional data to facilitate enrichment of transaction records is generally indicated at flowchart 400 in FIG. 4.

In the process 400 of FIG. 4, at step S402, transaction data for a geographical location that corresponds to a clustered merchant may be retrieved based on a predetermined parameter. The transaction data may be retrieved via an application programming interface. In an exemplary embodiment, the transaction data may correspond to information that is captured when a transaction is initiated between a merchant and a customer such as, for example, when the customer purchases goods and/or services from the merchant. The transaction data may include information that relates to the transaction such as, for example, a time dimension, a numerical value, a customer identifier, a merchant identifier, and a zip code.

In another exemplary embodiment, the clustered merchant may relate to a merchant with multiple locations within a geographically delineated area such as, for example, a postal code area or a zip code area. For example, merchant A may be classified as a clustered merchant when merchant A has multiple physical locations within zip code “12345.” In another exemplary embodiment, the exact locations of the clustered merchant may not be ascertainable from transaction information alone. For example, when merchant A has more than one location in zip code “12345,” the exact location of a transaction that took place at merchant A may not be ascertainable from transaction information that only includes zip code “12345.” As will be appreciated by a person of ordinary skill in the art, the clustered merchant may correspond to any entity that engages in the provisioning of goods and/or services for a fee.

In another exemplary embodiment, the transaction data may be retrieved in response to a transaction data enrichment request. The transaction data enrichment request may relate to a request to append the transaction data with corresponding contextual information. For example, in response to a transaction data enrichment request for merchant A, transaction data may be automatically retrieved for a geographical location that corresponds to merchant A.

In another exemplary embodiment, the predetermined parameter may include a zip code parameter. The zip code parameter may include a radial distance from the clustered merchant that is automatically adjusted based on a location density of the clustered merchant. For example, the radial distance for merchant A may be automatically adjusted when merchant A has several locations that are tightly packed in a small geographical area. In another exemplary embodiment, the predetermined parameter may be based on a predetermined setting. The setting may relate to the automatic adjustment of the radial distance from the clustered merchant. For example, the predetermined setting may indicate that the radial distance from merchant A may be decreased for densely packed locations with small zip codes and increased for lightly packed locations with large zip codes.

At step S404, proximate transactional data that correspond to the clustered merchant may be identified from the transaction data. In an exemplary embodiment, the proximate transactional data may include customer transaction data that is within a proximity of the clustered merchant. The customer transaction data may include the transactions that are made at another merchant by a customer of the clustered merchant. For example, transactions made within the vicinity of merchant A may be identified for customers of merchant A. As will be appreciated by a person of ordinary skill in the art, the proximate transactional data may include transaction information for customers who have transacted at both the clustered merchant as well as other merchants within the same vicinity as the clustered merchant.

At step S406, transactions in the proximate transactional data may be linked to the clustered merchant. In an exemplary embodiment, the transactions may be linked to each location of the clustered merchant in the geographical location. For example, transactions made at other merchants within the vicinity of a location of merchant A are linked to that location. In another exemplary embodiment, the transactions may correspond to purchasing activities of customers who also transacted at the location of the clustered merchant. For example, other transactions of customers who have transacted with a location of merchant A may be linked to the location.

At step S408, a weighted score for each of the transactions may be computed based on characteristics of the transactions. In an exemplary embodiment, the characteristics may include at least one from among a time characteristic and an exponential decay characteristic. The time characteristic may include a time difference between a first transaction at the clustered merchant and a second transaction at another merchant. For example, the weighted score for a particular transaction at another merchant may be computed based on the time before or the time since the transaction with merchant A.

In another exemplary embodiment, the exponential decay characteristic may be usable to emphasize various aspects of the transactions. For example, the exponential decay may be usable to emphasize recent transactions versus older transactions with less statistical value. In another exemplary embodiment, the weighted score for each of the transactions may be represented graphically on a graphical user interface. For example, the weighted score may be represented graphically by using circles, wherein larger circles may indicate a shorter time between the other merchant transactions and the merchant A transactions.

At step S410, a transaction centroid for each location of the clustered merchant may be calculated by using the corresponding weighted score and a result of the linking. In another exemplary embodiment, the centroid may correspond to a geometric center of a plurality of transaction points that represents the arithmetic mean position of the plurality of transaction points. For example, the transaction centroid of a location of merchant A may represent the mean position of the other merchant transactions within the vicinity of the location of merchant A. In another exemplary embodiment, the transaction centroid may be time weighted based on the weighted score and include positional values. The positional values may include a time weighted transaction latitude and a time weighted transaction longitude.

At step S412, geospatial information for each location of the clustered merchant may be determined based on a distance to the corresponding transaction centroid. In an exemplary embodiment, the geospatial information may include location specific information such as, for example, an address of a particular location. The geospatial information may be associated with the corresponding location and persisted consistent with disclosures in the present application.

In another exemplary embodiment, the distance may relate to an interval between known information such as, for example, a known address and a transaction centroid that corresponds to a location of the clustered merchant. The interval may represent a likelihood of association between the known information and the location of the clustered merchant. For example, when a transaction centroid that corresponds to a location of merchant A is near a known address, a likelihood exist that the known address belongs to the location. In another exemplary embodiment, the distance may represent a probability of association between the known information and a location of the clustered merchant. For example, a small distance may represent a strong likelihood that the known information belongs to the location, while a large distance may indicate that the known information is not likely to belong to the location.

In another exemplary embodiment, probabilistic estimates of the geospatial information may be determined by using a model. The model may include at least one from among a machine learning model, a statistical model, a mathematical model, a process model, and a data model. The model may also include stochastic models such as, for example, a Markov model that is used to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, logistic regression analysis, etc. In another exemplary embodiment, machine learning analytical techniques may include unsupervised learning algorithms such as, for example, Apriori analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

In another exemplary embodiment, an uncertainty metric may be computed for the geospatial information that corresponds to each location of the clustered merchant. The uncertainty metric may correspond to a relative uncertainty value of the determined geospatial information. Consistent with disclosures in the present application, the uncertainty metric may relate to a likelihood that the determined geospatial information is accurately associated with the location of the clustered merchant. The uncertainty metric may be determined by using information such as, for example, the number of available transactions from other merchants and the proximity of the next closest location to the transaction centroid. In another exemplary embodiment, the model may be further trained by using the uncertainty metric. The resulting uncertainty metric may be fed back into the model for a feedback loop that further tunes the model.

In another exemplary embodiment, a graphical element may be generated. The graphical element may include information that relates to the clustered merchant, the corresponding geospatial information, and the corresponding uncertainty metric. The graphical element may be displayed for a user via a graphical user interface to inform the user of the relative uncertainty of a given geospatial information determination.

In another exemplary embodiment, the determined geospatial information may be validated based on location information such as, for example, a store identifier from the clustered merchant. The location information may be automatically retrieved from a data repository of the clustered merchant. For example, store identifiers may be automatically retrieved from the clustered merchant and used with transaction information to determine whether the determined geospatial information is accurate. In another exemplary embodiment, information relating to the validation may be displayed via a graphical user interface together with the determined geospatial information for a user.

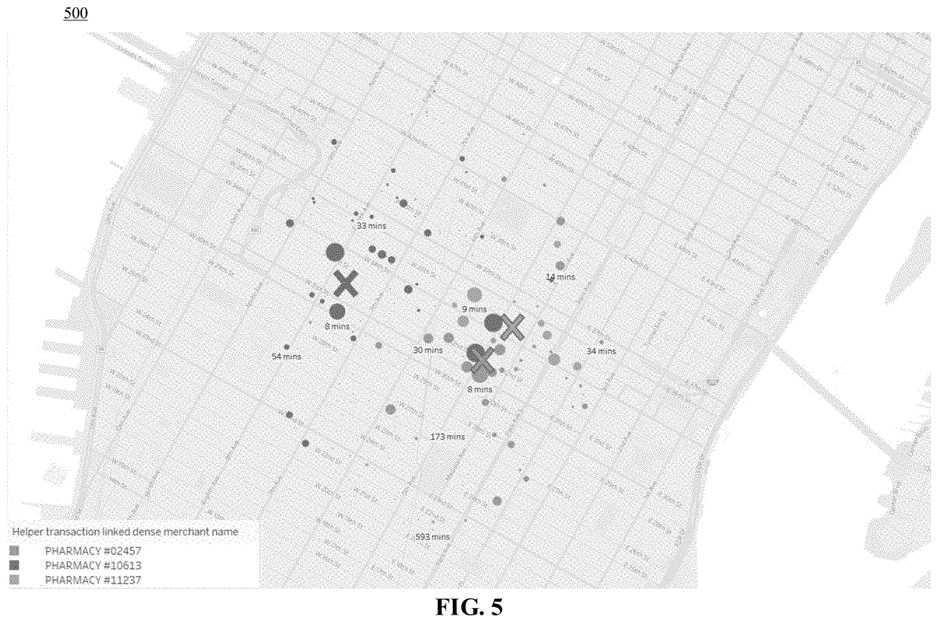

FIG. 5 is a weighted score and transaction centroid screen shot 500 that illustrates a graphical user interface that is usable for implementing a method for providing geospatial information for clustered merchants based on proximate transactional data to facilitate enrichment of transaction records, according to an exemplary embodiment. In FIG. 5, information relating to the clustered merchant may be represented graphically on a map consistent with disclosures in the present application.

As illustrated in FIG. 5, the transactions that are usable to determine geospatial information for a clustered merchant may be represented on the map as circles. The circles may be color coded to represent a link between the transactions and a location of the clustered merchant. The circles may be graphically represented with various sizes based on the corresponding weighted score. The transaction centroids that correspond to each group of transactions may be represented as an “X” on the map. Consistent with disclosures in the present application, the transaction centroid may correspond to an arithmetic mean position of all grouped transaction points. The transaction centroids may be color coded to match the corresponding grouped transaction points.

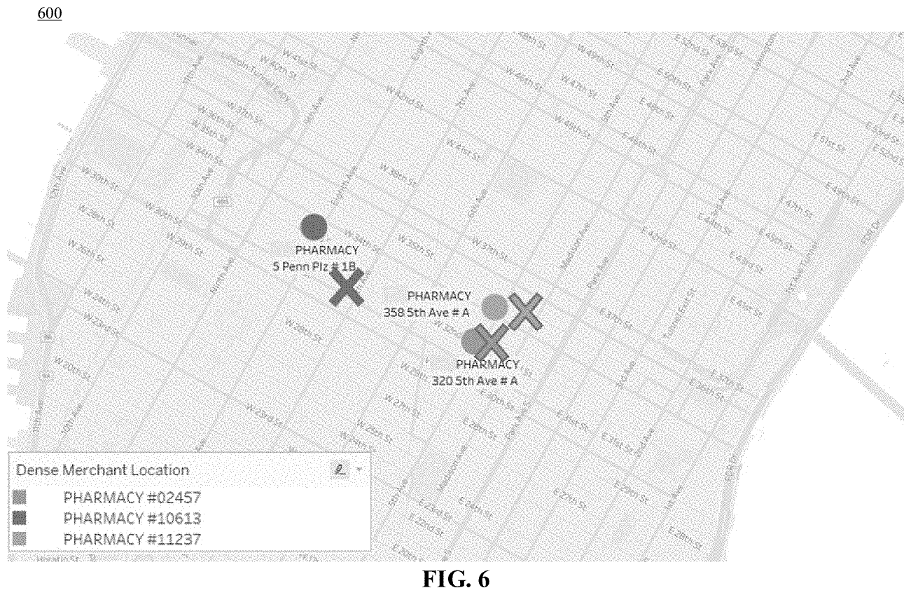

FIG. 6 is a geospatial information screen shot 600 that illustrates a graphical user interface that is usable for implementing a method for providing geospatial information for clustered merchants based on proximate transactional data to facilitate enrichment of transaction records, according to an exemplary embodiment. In FIG. 6, information relating to the clustered merchant may be represented graphically on a map consistent with disclosures in the present application.

As illustrated in FIG. 6, known addresses of the clustered merchant may be graphically represented on a map together with graphical representations of transaction centroids. A relative distance between the known addresses and the transaction centroids may be determined consistent with disclosures in the present application. A known address may be associated with a transaction centroid based on the determined relative distance. For example, a particular store location may be associated with an address based on a relative closeness between the transaction centroid that corresponds to the particular store location and the address.

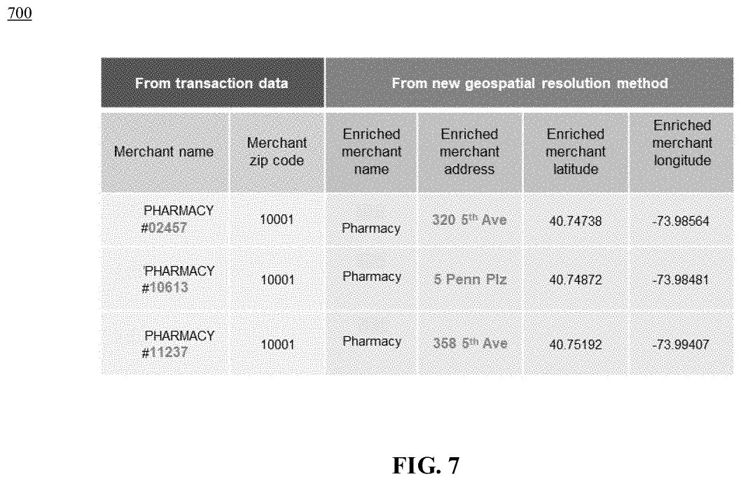

FIG. 7 is a screen shot 700 of a data enrichment table that illustrates a graphical user interface that is usable for implementing a method for providing geospatial information for clustered merchants based on proximate transactional data to facilitate enrichment of transaction records, according to an exemplary embodiment. In FIG. 7, information relating to the clustered merchant may be represented graphically on a chart consistent with disclosures in the present application.

As illustrated in FIG. 7, determined geospatial information such as, for example, an address, a latitude, and a longitude may be associated with locations of a clustered merchant. The associated geospatial information may be usable to enrich transactional data for each location of the clustered merchant.

Accordingly, with this technology, an optimized process for providing geospatial information for clustered merchants based on proximate transactional data to facilitate enrichment of transaction records is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing geospatial information for at least one clustered merchant based on proximate transactional data, the method being implemented by at least one processor, the method comprising:
retrieving, by the at least one processor via an application programming interface, transaction data for a geographical location that corresponds to the at least one clustered merchant based on a predetermined parameter;
identifying, by the at least one processor from the transaction data, the proximate transactional data that correspond to the at least one clustered merchant;
linking, by the at least one processor, at least one transaction in the proximate transactional data to each of the at least one clustered merchant;
computing, by the at least one processor, a weighted score for each of the at least one transaction based on at least one characteristic;
calculating, by the at least one processor, a transaction centroid for each of the at least one clustered merchant by using the corresponding weighted score and a result of the linking; and
determining, by the at least one processor, the geospatial information for each of the at least one clustered merchant based on a distance to the corresponding transaction centroid.

2. The method of claim 1, wherein the predetermined parameter includes a zip code parameter, the zip code parameter including a radial distance from the at least one clustered merchant that is automatically adjusted based on a location density of the at least one clustered merchant.

3. The method of claim 1, wherein the proximate transactional data includes customer transaction data that is within a proximity of the at least one clustered merchant, the customer transaction data including the at least one transaction that is made at another merchant by a customer of the at least one clustered merchant.

4. The method of claim 1, wherein the at least one characteristic includes at least one from among a time characteristic and an exponential decay characteristic, the time characteristic including a time difference between a first transaction at the at least one clustered merchant and a second transaction at another merchant.

5. The method of claim 1, further comprising:
computing, by the at least one processor, at least one uncertainty metric for the geospatial information that corresponds to each of the at least one clustered merchant, the at least one uncertainty metric corresponding to a relative uncertainty value of the determined geospatial information;
generating, by the at least one processor, at least one graphical element, the at least one graphical element including information that relates to the at least one clustered merchant, the corresponding geospatial information, and the corresponding at least one uncertainty metric; and
displaying, by the at least one processor via a graphical user interface, the at least one graphical element.

6. The method of claim 1, wherein the geospatial information is determined by using at least one model, the at least one model including at least one from among a machine learning model, a statistical model, a mathematical model, a process model, and a data model.

7. The method of claim 1, further comprising:
receiving, by the at least one processor via a graphical user interface, at least one data enrichment request, the at least one data enrichment request relating to instruction to append a set of the transaction data with corresponding contextual information; and
enriching, by the at least one processor, the set of the transaction data with the corresponding geospatial information,
wherein the geospatial information is associated with the corresponding at least one clustered merchant in the set of the transaction data.

8. The method of claim 7, wherein the geospatial information relates to location specific information that corresponds to each of the at least one clustered merchant, the location specific information including at least one from among a street address, a latitude, and a longitude of the at least one clustered merchant.

9. The method of claim 1, wherein the transaction centroid corresponds to a geometric center of the proximate transactional data for each of the at least one clustered merchant, the geometric center representing an arithmetic mean position between each of a plurality of transaction points in the proximate transactional data.

10. A computing device configured to implement an execution of a method for providing geospatial information for at least one clustered merchant based on proximate transactional data, the computing device comprising:
a processor;
a memory; and
a communication interface coupled to each of the processor and the memory, wherein the processor is configured to:
retrieve, via an application programming interface, transaction data for a geographical location that corresponds to the at least one clustered merchant based on a predetermined parameter;
identify, from the transaction data, the proximate transactional data that correspond to the at least one clustered merchant;
link at least one transaction in the proximate transactional data to each of the at least one clustered merchant;
compute a weighted score for each of the at least one transaction based on at least one characteristic;
calculate a transaction centroid for each of the at least one clustered merchant by using the corresponding weighted score and a result of the linking; and
determine the geospatial information for each of the at least one clustered merchant based on a distance to the corresponding transaction centroid.

11. The computing device of claim 10, wherein the predetermined parameter includes a zip code parameter, the zip code parameter including a radial distance from the at least one clustered merchant that is automatically adjusted based on a location density of the at least one clustered merchant.

12. The computing device of claim 10, wherein the proximate transactional data includes customer transaction data that is within a proximity of the at least one clustered merchant, the customer transaction data including the at least one transaction that is made at another merchant by a customer of the at least one clustered merchant.

13. The computing device of claim 10, wherein the at least one characteristic includes at least one from among a time characteristic and an exponential decay characteristic, the time characteristic including a time difference between a first transaction at the at least one clustered merchant and a second transaction at another merchant.

14. The computing device of claim 10, wherein the processor is further configured to:
compute at least one uncertainty metric for the geospatial information that corresponds to each of the at least one clustered merchant, the at least one uncertainty metric corresponding to a relative uncertainty value of the determined geospatial information;
generate at least one graphical element, the at least one graphical element including information that relates to the at least one clustered merchant, the corresponding geospatial information, and the corresponding at least one uncertainty metric; and
display, via a graphical user interface, the at least one graphical element.

15. The computing device of claim 10, wherein the processor is further configured to determine the geospatial information by using at least one model, the at least one model including at least one from among a machine learning model, a statistical model, a mathematical model, a process model, and a data model.

16. The computing device of claim 10, wherein the processor is further configured to:
receive, via a graphical user interface, at least one data enrichment request, the at least one data enrichment request relating to instruction to append a set of the transaction data with corresponding contextual information; and
enrich the set of the transaction data with the corresponding geospatial information,
wherein the geospatial information is associated with the corresponding at least one clustered merchant in the set of the transaction data.

17. The computing device of claim 16, wherein the geospatial information relates to location specific information that corresponds to each of the at least one clustered merchant, the location specific information including at least one from among a street address, a latitude, and a longitude of the at least one clustered merchant.

18. The computing device of claim 10, wherein the transaction centroid corresponds to a geometric center of the proximate transactional data for each of the at least one clustered merchant, the geometric center representing an arithmetic mean position between each of a plurality of transaction points in the proximate transactional data.

19. A non-transitory computer readable storage medium storing instructions for providing geospatial information for at least one clustered merchant based on proximate transactional data, the storage medium comprising executable code which, when executed by a processor, causes the processor to:
retrieve, via an application programming interface, transaction data for a geographical location that corresponds to the at least one clustered merchant based on a predetermined parameter;
identify, from the transaction data, the proximate transactional data that correspond to the at least one clustered merchant;
link at least one transaction in the proximate transactional data to each of the at least one clustered merchant;
compute a weighted score for each of the at least one transaction based on at least one characteristic;
calculate a transaction centroid for each of the at least one clustered merchant by using the corresponding weighted score and a result of the linking; and
determine the geospatial information for each of the at least one clustered merchant based on a distance to the corresponding transaction centroid.

20. The storage medium of claim 19, wherein the predetermined parameter includes a zip code parameter, the zip code parameter including a radial distance from the at least one clustered merchant that is automatically adjusted based on a location density of the at least one clustered merchant.
